(19) United States
(12) Patent Application Publication
(10) Pub. No.: US 2007/0044595 A1
(43) Pub. Date: Mar. 1, 2007

(54) Wrench engagement structures

(76) Inventor: Richard J. Macor, Hunterdon County, NJ (US)

Correspondence Address: Richard J. Macor;Proprietary Technologies, Inc., 26 Alpaugh Drive, Asbury, NJ, 08802-1213, US

(21) Appl. No.: 11/591,923

(22) Filed: Nov. 2, 2006

Related U.S. Application Data
(63) Continuation-in-part of application No. 11/504,153, filed on Aug. 15, 2006.
Application No. 11/504,153 is a continuation-in-part of application No. 11/372,784, filed on Mar. 10, 2006, now Pat. No. 7,159,492.
Application No. 11/372,784 is a continuation-in-part of application No. 11/050,949, filed on Feb. 4, 2005, now abandoned.

(51) Int. Cl. B25B 13/06

(52) U.S. Cl. 81/121.1

(57) ABSTRACT

A wrench tool is described which comprises an orifice that is formed to control the rotation of a hexagonal work piece. The orifice is substantially cylindrical and includes an array of only eighteen principle longitudinal grooves positioned therein that substantially form a symmetrical pattern around an imaginary central axis. The eighteen grooves are formed and spaced apart so as to create an array of only eighteen principle longitudinal protuberances which also substantially form a symmetrical pattern around the imaginary central axis for engagement with the work piece. The protuberances are positioned apart relative to each other by predetermined distances whereas the least distance between any eight adjacent protuberances is less than the least distance between any ten adjacent protuberances.

### REFERENCES TO RELATED APPLICATIONS

This application relates to and is a continuation-in-part of copending U.S. patent application Ser. No. 11/504,153 filed on Aug. 15, 2006 entitled “Wrench engagement technologies;” which relates to and is a continuation-in-part of patent application Ser. No. 11/372,784 filed on Mar. 10, 2006 entitled “Wrench engagement structure;” which relates to and is a continuation-in-part of patent application Ser. No. 11/050,949 filed on Feb. 4, 2005 entitled “Wrench engagement technologies” which is now abandoned, all of which have been filed by the same inventor herein.

### FIELD OF THE INVENTION

The present invention relates to hand tools, particularly hand operated wrenches, and more particularly box type wrenches and wrench sockets.

### BACKGROUND OF THE INVENTION

Hand operated wrenches have been around for many years and most are designed to control the rotation of nuts, bolts and various fasteners. These wrenches usually have either a six or twelve point opening for turning the fasteners. It is believed by some that the six point design can apply more torque to a fastener then the twelve point design without “rounding” the fastener. On the other hand, the twelve point design is desirable because it requires less re-engagement swing arc than the six point design. The language of “re-engagement swing arc” shall be defined herein as the least amount of swing arc required (measured in degrees) for a wrench to re-engage a work piece such as a fastener that is being tightened or loosened. The minimum re-engagement swing arc of a twelve point wrench design is thirty degrees, or half of the minimum re-engagement swing arc of a six point design which is sixty degrees. Applicant contemplates an improved wrench that will require less re-engagement swing arc than each of the prior art six and twelve point wrench designs, while maintaining reasonable, if not substantial wrench strength to maximize the application of torque to a work piece such as a fastener, while minimizing fastener deformation, wrench wear and breakage.

### SUMMARY OF THE INVENTION

An embodiment of the present invention comprises an orifice that is formed to control the rotation of a hexagonal work piece. The orifice is substantially cylindrical and includes an array of only eighteen principle longitudinal grooves positioned therein that substantially form a symmetrical pattern around an imaginary central axis. The eighteen grooves are formed and spaced apart so as to create an array of only eighteen principle longitudinal protuberances which substantially form a symmetrical pattern around the imaginary central axis for engagement with the work piece. The protuberances are positioned apart relative to each other by predetermined distances, whereas, the least distance between any eight adjacent protuberances is less than the least distance between any ten adjacent protuberances. In some embodiments of the present invention each protuberance has a predetermined height to length ratio, whereas, each protuberance has a height equal to or less than about one third of its length.

With regards to the present invention above, applicant considers the following objectives:

It is an important objective of the present invention that it requires less re-engagement swing arc than each of the prior art six and twelve point wrench designs.

It is another important objective of the present invention that it provide a user with better accessibility to fasteners than each of the prior art six and twelve point wrench designs, especially in limited access environments.

It is another important objective of the present invention that it provide better synchronization and initial engagement with a work piece such as a fastener, than each of the prior art six and twelve point wrench designs.

It is another important objective of the present invention that it achieves reasonable, if not substantial wrench strength to maximize the application of torque to a work piece such as a fastener, while minimizing fastener deformation, wrench wear and breakage.

And, it is yet another important objective of the present invention that it be cost efficient to manufacture and commercially viable.

### BRIEF DESCRIPTION OF THE DRAWINGS

FIG. 1 shows a top plan view of a hexagonal work piece such as a bolt head.

FIG. 2 shows a top plan cut view of a box type wrench having a wrench head comprising an embodiment of the present invention wrench engagement structures.

FIG. 3 shows an enlarged fragmentary view of the wrench head shown in FIG. 2.

FIG. 4 shows a top plan view of a wrench socket comprising another embodiment of the present invention wrench engagement structures.

FIG. 5 shows a top plan cut view of a prior art wrench head with eighteen teeth.

FIG. 6 shows an enlarged fragmentary view of the prior art wrench head shown in FIG. 5.

FIG. 7 shows a top plan cut view of another prior art wrench head with eighteen teeth.

FIG. 8 shows an enlarged fragmentary view of the prior art wrench head shown in FIG. 7.

### DETAILED DESCRIPTION OF THE DRAWINGS

The various drawings provided herein are for the purpose of illustrating possible embodiments of the present invention and not for the purpose of limiting same. Therefore, the drawings herein represent only a few of the many possible embodiments and/or variations of the present invention.

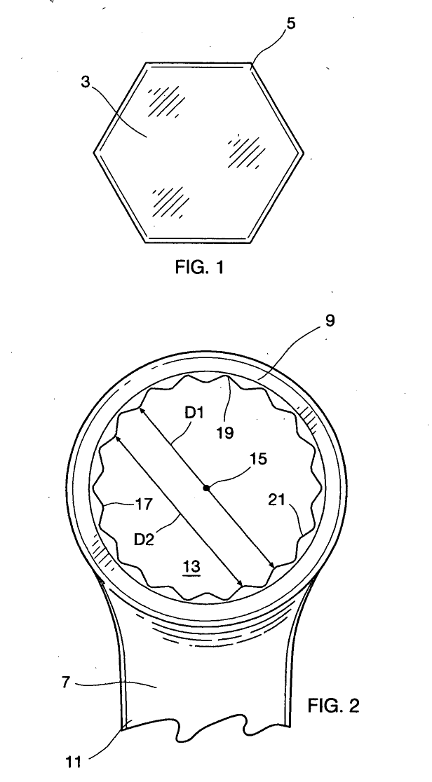

FIG. 1 shows a top plan view of a hexagonal work piece such as a bolt head. Hexagonal work piece 3 has six points represented by point 5. The present invention wrench engagement structures are generally designed to function best with hexagonal fasteners such as nuts, bolts, hexagonal screws etc.

FIG. 2 shows a top plan cut view of a box type wrench having a wrench head comprising an embodiment of the present invention wherein wrench tool 7 has a wrench head 9, and handle 11, and an orifice 13 formed to control the rotation of a hexagonal work piece such as that shown in FIG. 1. Orifice 13 is substantially cylindrical and comprises an array of only eighteen principle longitudinal grooves positioned therein substantially forming a symmetrical pattern around an imaginary central axis 15. Groove 19 is representative of such grooves. The eighteen grooves are formed and spaced apart so as to create an array of only eighteen principle longitudinal protuberances. Protuberance 17 is representative of such protuberances. The protuberances form a symmetrical pattern around the imaginary central axis 15 as shown for engagement with a work piece, such as that shown in FIG. 1. The present invention is designed to function best with only eighteen longitudinal grooves and only eighteen longitudinal protuberances. Each protuberance is formed having at least one engaging surface such as engaging surface 21 which may be substantially flat, arcuate, concave, convex and/or any combination thereof. In this Figure each protuberance is formed having engaging surfaces that are substantially flat. The protuberances of the present invention are positioned apart relative to each other by predetermined distances, whereas, the least distance between any eight adjacent protuberances D2 is less than the least distance between any ten adjacent protuberances D1. Preferably, the protuberances of the present invention are positioned apart relative to each other such that the least distance between any eight adjacent protuberances D2 is equal to or greater than about eighty-eight percent of the least distance between any ten adjacent protuberances D1; and, equal to or less than about ninety-eight percent of the least distance between any ten adjacent protuberances D1 as shown. More preferably, the protuberances of the present invention are positioned apart relative to each other such that the least distance between any eight adjacent protuberances D2 is equal to or greater than about ninety percent of the least distance between any ten adjacent protuberances D1; and, equal to or less than about ninety-six percent of the least distance between any ten adjacent protuberances D1 as shown. And most preferably, the protuberances of the present invention are positioned apart relative to each other such that the least distance between any eight adjacent protuberances D2 is equal to or greater than about ninety-two percent of the least distance between any ten adjacent protuberances D1; and, equal to or less than about ninety-four percent of the least distance between any ten adjacent protuberances D1 as shown. Such predetermined dimensions and spacing of the protuberances are significant structural features of the present invention that are clearly distinct from all other prior art wrench designs that do not have exactly eighteen teeth.

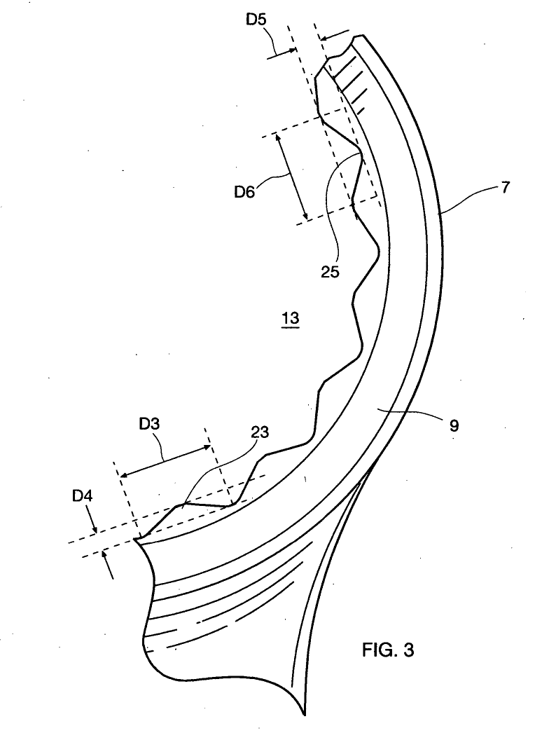

FIG. 3 shows an enlarged fragmentary view of the wrench head shown in FIG. 2. In this view a closer look at the grooves and protuberances is provided. In this embodiment of the present invention, each protuberance has a height to length ratio, whereas, the height of each protuberance is preferably equal to or less than about one third of its length; and more preferably, the height of each protuberance is equal to or less than about one quarter of its length. Here the height D4 of protuberance 23 is about eighteen percent of its length D3 as shown. The length of a wrench protuberance shall be defined herein as the least, straight line distance between the two outer points of the protuberance at which the protuberance starts to enter the orifice. The height of a wrench protuberance shall be defined herein as the least, straight line distance between the imaginary line created by the length of the protuberance defined above, and the point of the protuberance closest to the orifice central axis.

Also shown in FIG. 3 is groove 25 with a depth dimension D5 and a length dimension D6. In this embodiment of the present invention, each groove has a depth to length ratio, whereas, the depth of each groove is preferably equal to or less than about one third of its length. Here the depth D5 of groove 25 is about twenty-seven percent of its length D6 as shown. The length of a wrench groove shall be defined herein as the least, straight line distance between the centers of two adjacent protuberances. The depth of a wrench groove shall be defined herein as the least, straight line distance between the imaginary line created by the length of the groove defined above, and the point of the groove farthest away from the orifice central axis.

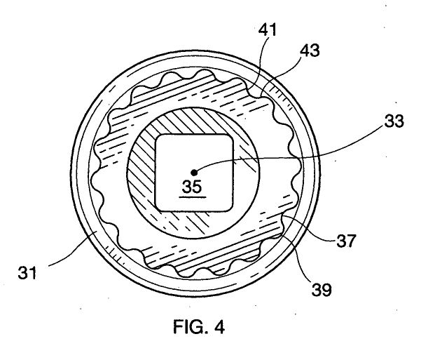

FIG. 4 shows a top plan view of a wrench socket comprising another embodiment of the present invention wrench engagement structures. Here wrench socket 31 comprises an orifice 35 that is formed to control the rotation of a hexagonal work piece such as a nut or bolt etc. Orifice 35 is substantially cylindrical and includes an array of only eighteen principle longitudinal grooves. The grooves substantially form a symmetrical pattern around imaginary central axis 35. Longitudinal groove 39 is representative of such grooves. The eighteen grooves are formed and spaced apart so as to create an array of only eighteen principle longitudinal protuberances which substantially form a symmetrical pattern around imaginary central axis 35 for engagement with a work piece such as the work piece shown in FIG. 1. Longitudinal protuberance 37 is representative of such protuberances. The protuberances are positioned apart relative to each other by predetermined distances whereas the least distance between any eight adjacent protuberances is less than the least distance between any ten adjacent protuberances. In this embodiment of the present invention, the least distance measured between any eight adjacent protuberances is about ninety-three percent of the least distance measured between any ten adjacent protuberances. And, each protuberance has a predetermined height to length ratio, whereas, the dimension of each protuberance is about one quarter of its length; and, each groove has a predetermined depth to length ratio, whereas, the depth of each groove is about one third of its length.

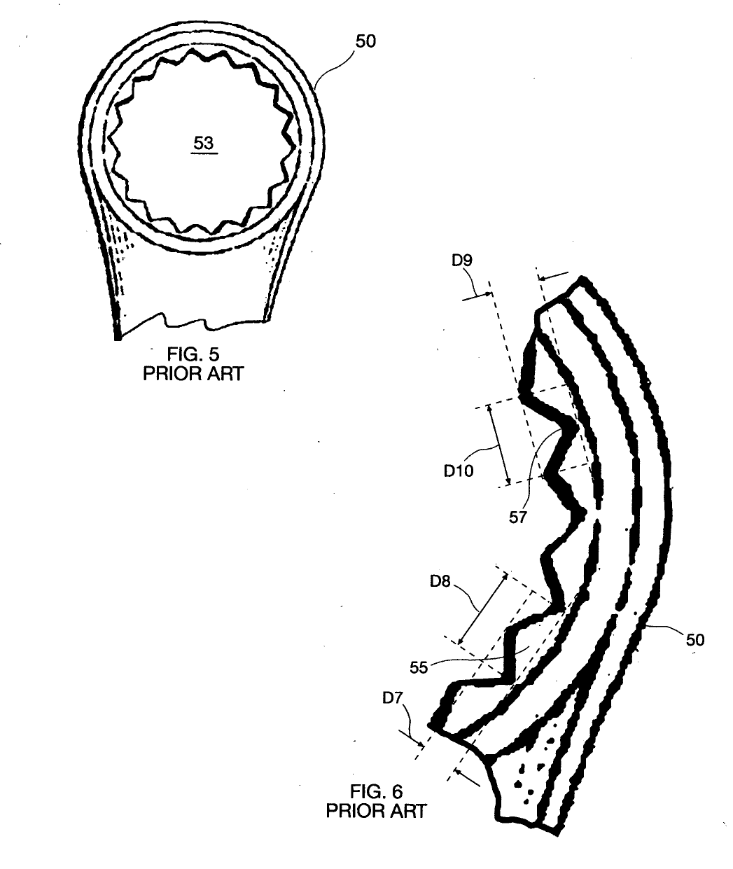

FIG. 5 shows a top plan cut view of a prior art wrench head 50 with orifice 53 having eighteen teeth; and, FIG. 6 shows an enlarged fragmentary view of the prior art wrench head shown in FIG. 5. Referring now to both FIGS. 5 and 6 together, each protuberance such as protuberance 55, has a height D7 that is about forty-one percent of its length D8 as shown. And, each groove such as groove 57, has a depth D9 that is about half of its length D10 as shown. Again, the length of a wrench protuberance shall be defined herein as the least, straight line distance between the two outer points of the protuberance at which the protuberance starts to enter the orifice. The height of a wrench protuberance shall be defined herein as the least, straight line distance between the imaginary line created by the length of the protuberance defined above, and the point of the protuberance closest to the orifice central axis. The length of a wrench groove shall be defined herein as the least, straight line distance between the centers of two adjacent protuberances. The depth of a wrench groove shall be defined herein as the least, straight line distance between the imaginary line created by the length of the groove defined above, and the point of the groove farthest away from the orifice central axis. Accordingly, the height to length ratio of each protuberance of this prior art wrench is, in fact, significantly different than the height to length ratio of each protuberance of the present invention, whereas, each protuberance of the present invention is both structurally and functionally shallower than each protuberance of this prior art wrench. Also, the depth to length ratio of each groove of this prior art wrench is, in fact, significantly different than the depth to length ratio of each groove of the present invention, whereas, each groove of the present invention is both structurally and functionally shallower than each groove of the prior art wrench shown.

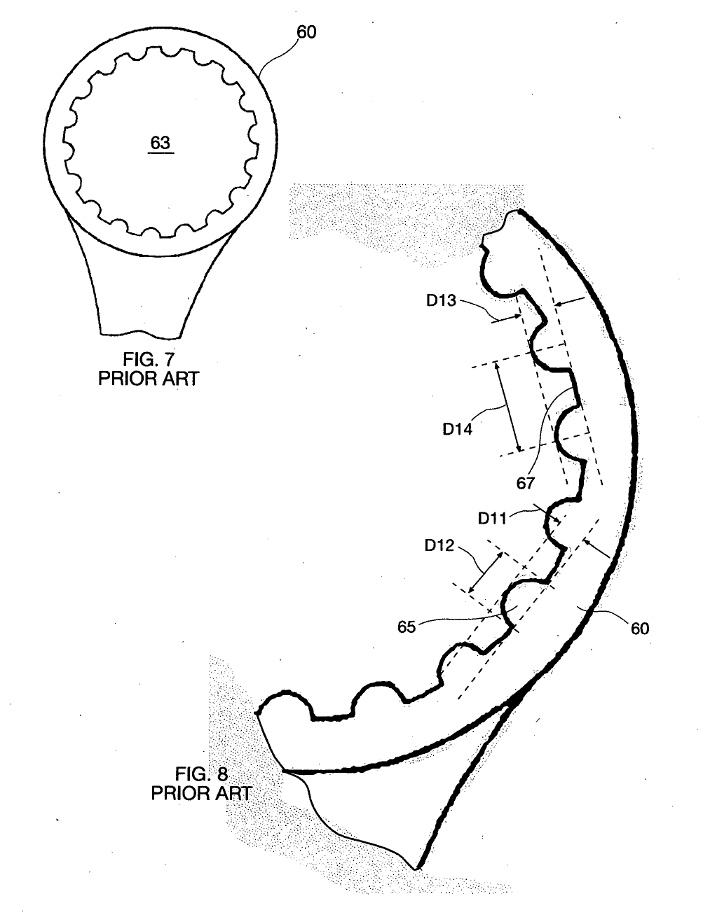

FIG. 7 shows a top plan cut view of another prior art wrench head 60 with orifice 63 having eighteen teeth; and, FIG. 8 shows an enlarged fragmentary view of the prior art wrench head shown in FIG. 7. Referring now to both FIGS. 7 and 8 together, each protuberance such as protuberance 65, has a height D11 that is about half (fifty percent) of its length D12 as show. And, each groove such as groove 67, has a depth D13 that is about thirty-seven percent of its length D14 as shown. Accordingly, the height to length ratio of each protuberance of this prior art wrench is, in fact, significantly different than the height to length ratio of each protuberance of the present invention, whereas, each protuberance of the present invention is both structurally and functionally shallower than each protuberance of this prior art wrench. Also, the depth to length ratio of each groove of this prior art wrench is, in fact, significantly different than the depth to length ratio of each groove of the present invention, whereas, each groove of present invention is structurally and functionally shallower than each groove of this prior art wrench.

The predetermined, dimensional configurations of the present invention embodiments described above provide superior “off corner” loading, and force distribution between the wrench and work piece, to minimize fastener “rounding” wrench wear and breakage. In addition, the minimum re-engagement swing arc of the present invention is just 20 degrees, while the prior art six and twelve point designs (not shown) require 60 degrees and 30 degrees respectively. It is believed that the present invention wrench engagement structures will have many applications to different wrenches, including but not limited to box wrenches, double-box wrenches, combination wrenches and wrench sockets of all lengths.

Although illustrative embodiments have been described herein in detail, it should be noted and will be appreciated by those skilled in the art that numerous variations may be made within the scope of this invention without departing from the principles and chief advantages of this invention. Unless otherwise specifically stated, the terms and expressions have been used herein as terms of description and not limitation. There is no intention to use the terms or expressions to exclude any equivalents of features shown and described or portions thereof, and this invention should be predetermined in accordance with the claims that follow, or the equivalence thereof.

Having thus described the invention, the following is claimed:

1. A wrench tool comprising an orifice formed to control the rotation of a hexagonal work piece, said orifice being substantially cylindrical and comprising an array of only eighteen principle longitudinal grooves positioned therein substantially forming a symmetrical pattern around an imaginary central axis, said eighteen grooves being formed and spaced apart so as to create an array of only eighteen principle longitudinal protuberances, said protuberances substantially forming a symmetrical pattern around said imaginary central axis for engagement with said work piece, said protuberances being positioned apart relative to each other by predetermined distances whereas the least distance between any eight adjacent protuberances being less than the least distance between any ten adjacent protuberances, and, each said protuberance having a predetermined height to length ratio, whereas, each said protuberance has a height equal to or less than about one third of its length.

2. A wrench tool of claim 1, wherein each said protuberance has a height equal to or less than about one quarter of its length.

3. A wrench tool of claim 1, wherein said wrench tool is a wrench socket.

4. A wrench tool of claim 1, wherein said wrench tool comprises a box type wrench head.

5. A wrench tool of claim 1, wherein each said protuberance comprises at least one substantially flat engaging surface.

6. A wrench tool of claim 1, wherein each said protuberance comprises at least one substantially arcuate engaging surface.

7. A wrench tool of claim 2, wherein said wrench tool is a wrench socket.

8. A wrench tool of claim 2, wherein said wrench tool comprises a box type wrench head.

9. A wrench tool of claim 2, wherein each said protuberance comprises at least one substantially flat engaging surface.

10. A wrench tool of claim 2, wherein each said protuberance comprises at least one substantially arcuate engaging surface.

11. A wrench tool comprising an orifice formed to control the rotation of a hexagonal work piece, said orifice being substantially cylindrical and comprising an array of only eighteen principle longitudinal grooves positioned therein substantially forming a symmetrical pattern around an imaginary central axis, said eighteen grooves being formed and spaced apart so as to create an array of only eighteen principle longitudinal protuberances, said protuberances substantially forming a symmetrical pattern around said imaginary central axis for engagement with said work piece, said protuberances being positioned apart relative to each other by predetermined distances whereas the least distance between any eight adjacent protuberances being less than the least distance between any ten adjacent protuberances, and, each said groove having a predetermined depth to length ratio, whereas, each said groove has a depth equal to or less than about one third of its length.

12. A wrench tool of claim 11, wherein said wrench tool is a wrench socket.

13. A wrench tool of claim 11, wherein said wrench tool comprises a box type wrench head.

14. A wrench tool of claim 11, wherein each said groove comprises at least one substantially flat engaging surface.

15. A wrench tool of claim 11, wherein each said groove comprises at least one substantially arcuate engaging surface.

16. A wrench tool comprising an orifice formed to control the rotation of a hexagonal work piece, said orifice being substantially cylindrical and comprising an array of only eighteen principle longitudinal grooves positioned therein substantially forming a symmetrical pattern around an imaginary central axis, said eighteen grooves being formed and spaced apart so as to create an array of only eighteen principle longitudinal protuberances, said protuberances substantially forming a symmetrical pattern around said imaginary central axis for engagement with said work piece, said protuberances being positioned apart relative to each other by predetermined distances whereas the least distance between any eight adjacent protuberances being less than the least distance between any ten adjacent protuberances, each said protuberance having a predetermined height to length ratio, whereas, each said protuberance has a height equal to or less than about one third of its length, and, each said groove having a predetermined depth to length ratio, whereas, each said groove has a depth equal to or less than about one third of its length.

17. A wrench tool of claim 16, wherein said wrench tool is a wrench socket.

18. A wrench tool of claim 16, wherein said wrench tool comprises a box type wrench head.

19. A wrench tool of claim 16, wherein each said protuberance comprises at least one substantially flat engaging surface.

20. A wrench tool of claim 16, wherein each said protuberance comprises at least one substantially arcuate engaging surface.
